(19) United States
(12) Patent Application Publication
(10) Pub. No.: US 2016/0003738 A1
(43) Pub. Date: Jan. 7, 2016

(54) DEVICE AND METHOD FOR MEASURING THE OXYGEN CONTENT IN WELDING PROCESSES

(71) Applicant: ILLINOIS TOOL WORKS INC., Glenview, IL (US)

(72) Inventor: Sebatsian HARDER, Hilzingen (DE)

(21) Appl. No.: 14/768,499

(22) PCT Filed: Feb. 15, 2014
(86) PCT No.: PCT/US2014/016642

§ 371 Date: Aug. 18, 2015

(30) Foreign Application Priority Data
Feb. 25, 2013 (DE) 102013203087.8

(51) Int. Cl. G01N 21/64; B23K 9/095; B23K 9/16; B23K 9/00

(52) U.S. Cl. CPC G01N 21/6428; B23K 9/0052; B23K 9/0956; B23K 9/16; G01N 2021/6432

(57) ABSTRACT

The invention relates to a device for measuring the oxygen content in welding processes, in particular shielded arc welding, the device having at least one sensor element for sensing the oxygen content of a shielding atmosphere. With the aim of providing a device for measuring the oxygen content in welding processes that provides stable measured values for the residual oxygen content even at very high temperatures of the welding process and is ready to use after a very short time, it is envisaged to design the sensor element as an optical oxygen sensor.

The present invention relates to a device for measuring the oxygen content in welding processes according to the preamble of independent patent claim 1. The invention also relates to a method for measuring the oxygen content according to the preamble of independent patent claim 10.

Accordingly, the present invention relates to a device and a method for measuring the oxygen content in welding processes, in particular shielded arc welding, at least one sensor element for sensing the oxygen content of a shielding atmosphere being provided.

Such devices and methods for measuring the oxygen content in welding processes are known in principle from the prior art. In particular in the case of shielded arc welding, a shielding gas is made to flow around the weld seam during the welding operation in order to displace oxygen. The shielding gas is an inert gas that shields the weld seam from oxidation and scaling. Apart from a visual flaw, even slight oxidation can greatly restrict the corrosion resistance of the weld seam. In order to establish whether the region to be worked is sufficiently flooded with a shielding gas, it is necessary to monitor the residual oxygen content continuously at the welding point.

In particular in the chemical industry, particularly high-quality welded connections are required for plant and apparatus. To provide such connections for the construction of reaction towers, pumps and pipes, material such as titanium, tantalum or zirconium are used, requiring special welding conditions during processing in order to ensure metallurgically satisfactory weld seams. It is not uncommon in such cases that the shielding atmosphere produced by the shielding gas must have an oxygen content of no more than 0.001 to 0.01% (10 to 100 ppm).

In order to ensure that there is actually such a low residual oxygen content in the shielding atmosphere, it must be measured exactly. The calculation formulae that are often used by those skilled in the art, based on time, amount of gas and volume, only provide very rough approximate values here, which however are inadequate in many applications. Accordingly, it is customary to provide in addition to the welding device devices for measuring the oxygen content. In this case, the conventional devices for measuring the oxygen content usually have a sensor element that determines the oxygen content by means of a zirconia sensor.

Zirconia sensors operate on the Nernst principle. Thin layers of platinum serving as electrodes are applied to both sides of a zirconia membrane. The zirconia membrane and the electrodes separate the measuring gas (here shielding gas) from the ambient air. If the layer of zirconia is heated to above 350 degrees, it becomes an oxygen ion conductor. As long as there is a difference between the oxygen concentrations on both sides of the zirconia membrane, the oxygen ions migrate from the side that has the higher oxygen partial pressure to the side that has the lower oxygen partial pressure, ultimately resulting in a drop in voltage at both electrodes. This voltage is a measure of the oxygen partial pressure of the measuring gas (shielding gas).

In the case of the zirconia sensors known from the prior art for measuring the oxygen content of the shielding gas atmosphere, it has been found to be problematic that they have a relatively high cross-sensitivity to the gases occurring in the welding operation. One reason for this is the ozone (O3) occurring during the welding process, causing the zirconia sensor to produce unstable measured values. Not even ozone filters or software-based solutions can decisively influence the aforementioned problems. Apart from this, the known zirconia sensors need a relatively long heating-up time (several minutes) to reach their required operating temperature of about 600° C. Finally, it is disadvantageous that the zirconia sensors have a high sensitivity to water vapor.

On account of the aforementioned problems, the present invention is based on the object of providing a device and a method for measuring the oxygen content in welding processes that provide stable measured values for the residual oxygen content even at very high temperatures of the welding process and are ready to use after a very short time.

This object is achieved according to the invention with regard to the device by the subject matter of independent patent claim 1 and with regard to the method by the subject matter of independent patent claim 10.

Accordingly, the device according to the invention for measuring the oxygen content in welding processes is distinguished by the fact that the sensor element is designed as an optical oxygen.

The advantages of the device according to the invention for measuring the oxygen content are obvious. For instance, as a result of the sensor element being designed as an optical oxygen sensor, the device according to the invention has virtually no cross-sensitivity to ozone (O3), occurring in particular in the welding process. The optical sensor element is additionally ready for use at any time and has a long useful life. It should also be mentioned in this connection that—by contrast with the known zirconia sensors—the optical sensor element is also water-resistant. Consequently, the optical sensor can even be used without any problem during the welding operation. Furthermore, as a result of the sensor element being designed as an optical oxygen sensor, a far quicker response is achieved when measuring the oxygen content. Finally, as a result of the optical oxygen sensor, particularly accurate measured values for the residual oxygen content of the shielding atmosphere are also made possible.

Advantageous developments of the device according to the invention for measuring the oxygen content in welding processes can be taken from the subclaims.

For instance, it is provided in a first embodiment that the at least one sensor element has a fluorescing medium, which can be brought into contact with the shielding atmosphere and is designed for sensing the oxygen content of the shielding atmosphere by means of fluorescence quenching.

This makes use of the phenomenon known as the “oxygen quenching process”. If organic molecules in particular are excited by light of a suitable wavelength, they begin to luminesce. This luminescence can be quenched by collisions with other suitable molecules, for example oxygen molecules (quenching). This means that the deactivation of the photochemically excited luminophores takes place without radiation, i.e. without the emission of photons. In the specific case of fluorescing media, this is referred to as fluorescence quenching. The fluorescence is generally the component of the luminescence that takes place as a result of a singlet-singlet transition and, depending on the material, takes place approximately 10⁻⁸ seconds after the original excitation.

As already mentioned, as an alternative to the fluorescence, the deactivation of the fluorescing medium may also take place without radiation, the excitation energy being transferred to the oxygen molecules by collision (oxygen quenching). This interaction between the excited fluorescing medium and the oxygen molecules increases the probability of a radiationless transition, and consequently reduces the intensity of the electromagnetic radiation that is generated by the fluorescing medium. Since such an energy transfer on the basis of the difference in energy between the respective energy states can only take place with certain molecules, the cross-sensitivity of a sensor element based on fluorescence quenching is considerably reduced. In particular, a suitable choice of the fluorescing medium can achieve the effect that the ozone molecules occurring during the welding process have no influence on the measuring result of the optical sensor element. For this purpose, it is possible for example to form the fluorescing medium from ruthenium, platinum or pyrene derivatives.

The sensor element may accordingly have at least one device for exciting the fluorescing medium and at least one photosensor for sensing electromagnetic radiation that is given off by the fluorescing medium as a result of a deactivation process. In this case, the photosensor is preferably designed as a CCD element, photosensor or photomultiplier.

According to a further embodiment, the device for exciting the fluorescing medium may be designed to give off a short (˜1 μs) excitation pulse to the fluorescing medium at previously determined time intervals. It is consequently not necessary to excite the fluorescing medium continuously, whereby energy can be saved. In addition, the lower heat input into the fluorescing medium achieves the effect that it has longer useful lives.

According to a further aspect, the device according to the invention for measuring the oxygen content has an evaluation unit, which is connected to the photosensor and is designed for determining the decay behavior over time of the fluorescent radiation of the fluorescing medium. This is of advantage in particular in connection with the pulsed excitation of the fluorescing medium. Directly after the pulsed excitation, the emitted radiation is thereby recorded by the photosensor. Conclusions concerning the oxygen quenching process can be taken from this, by way of the decay behavior over time of the fluorescent light. In particular, there is a more rapid decay behavior when there is a relatively great oxygen content of the shielding atmosphere than is the case with a lower oxygen concentration. Specifically, the decay behavior over time of the fluorescent light can be described by a simple exponential function. Accordingly, the oxygen content of the shielding atmosphere can be determined for a known fluorophore with the aid of the Stern-Volmer relationship. For this purpose, the device according to the invention may have a microprocessor, which is part of the evaluation unit.

By contrast with just measuring the intensity of the fluorescent light, measuring the decay behavior of the fluorescent radiation of the fluorescing medium offers the advantage that the measurement is insensitive to dirt particles on the surface of the fluorophore. Another important advantage of this measuring principle is that—depending on the response behavior of the photosensor—a measured value for the residual oxygen content can already be achieved within a few nanoseconds.

According to a further implementation of the device according to the invention, the evaluation unit is connected to an alarm device and is designed to emit an optical and/or acoustic alarm signal as soon as the oxygen content of the shielding atmosphere exceeds a previously determinable limit value. Accordingly, the device can automatically give off a warning signal if the oxygen content assumes too high a value to ensure a certain quality of the welded connection. Alternatively or in addition, it is conceivable that the evaluation unit is connected directly to a welding device and is designed to deactivate it automatically as soon as a previously determinable limit value is exceeded. It would in this way be ensured even in the case of an automatic welding process that the welding operation is only carried out when there are sufficiently small residual amounts of oxygen in the shielding atmosphere.

Finally, the values determined by the evaluation unit for the oxygen content of the shielding atmosphere can be stored continuously in a data memory of the device according to the invention in order to allow reliable documentation of the oxygen content during the welding process. Accordingly, conclusions concerning the quality of the welded connection can be drawn in an easy way even after the welding operation.

In a further embodiment, the device according to the invention for measuring the oxygen content has an intake unit, which is designed for the purpose of taking in a sample of the shielding atmosphere, in the direct vicinity of a weld seam, before and/or during a welding process, and feeding it to the optical sensor element. In other words, the sensor element may be designed as an aspiration oxygen sensor. This has the advantage that the device according to the invention can be produced and sold on its own, that is to say separately from the welding device. The device according to the invention can consequently be used in a large number of different applications for measuring the oxygen content of a shielding atmosphere. Alternatively, however, it is of course also conceivable to provide the optical sensor element directly on a welding device.

The present invention likewise provides a welding system, which has a welding device and the device described above for measuring the oxygen content. Such a welding system conforms to the highest demands for the quality of the welded connection.

The aforementioned welding device may be designed for example as an orbital welder for welding pipes. Orbital welding is a fully mechanized shielded arc welding method in which an arc is passed around pipes or other round bodies uninterruptedly through 360° by machine. In order also to conform to the high demands of the chemical industry, it is advantageous in particular to design the orbital welder with a closed housing, which is designed as a shielding chamber for receiving a shielding gas. The closed housing is of course designed in this case in such a way that the pipes to be welded are entirely enclosed and it is made to match the pipe diameter. In the shielding chamber, which is completely filled with a shielding gas, the welding head is passed around the pipes to be welded.

According to a further embodiment, the device for measuring the oxygen content is arranged in particular inside the closed housing of the welding device that is designed as a shielding chamber. The device for measuring the oxygen content is in this case designed for continuously determining the oxygen content within the housing. As an alternative to this, it is however also conceivable that the device for measuring the oxygen content is not arranged inside the housing of the welding device but has a suction device, which is connected to the interior space of the shielding chamber. The continuous measurement of the oxygen content within the shielding chamber allows the quality of the welded connection to be monitored better.

By contrast, it is known from the prior art to introduce shielding gas into the shielding chamber over a predetermined time period, the time period being made long enough to ensure that the residual oxygen content within the shielding chamber is low enough. Of course, this time period is merely based on empirical data and has the consequence that an unnecessarily large amount of shielding gas is introduced into the interior space of the shielding chamber. It should also be mentioned in this connection that the time required for filling the shielding chamber with shielding gas also depends on the pipe diameter of the pipes to be welded, making it even more difficult to estimate the time required for filling. By contrast with this, the device according to the invention for measuring the residual oxygen content that is designed to determine the oxygen content within the housing achieves the effect that the amount of shielding gas required can be determined exactly. This also ensures that the residual oxygen content within the shielding chamber can be monitored during the entire welding process.

According to a further implementation of the welding system according to the invention, it may also have a second device according to the invention for measuring the oxygen content. The second device for measuring the oxygen content is in this case designed in particular to measure the oxygen content within a lumen of the two pipes to be welded. It should be mentioned in this connection that only the outer diameter of the pipes is shielded by the shielding gas atmosphere within the shielding chamber from oxidation during the welding. In addition to this, in the case of orbital welding, the inner diameter, i.e. the lumen of the pipes, is flushed through with a further shielding gas, so that there is also a reduced oxygen content within the pipes. With the welding system according to the invention, it is not only possible to determine the oxygen content within the shielding chamber but also possible, according to this embodiment, to measure the residual oxygen content within the lumen of the pipes, whereby even the inner sides of the pipes can be welded to a high quality.

1. A device for measuring the oxygen content in welding processes, in particular shielded arc welding, the device having at least one sensor element for sensing the oxygen content of a shielding atmosphere, characterized in that the sensor element is designed as an optical oxygen sensor.

2. The device as claimed in claim 1, the optical oxygen sensor having a fluorescing medium, which can be brought into contact with the shielding atmosphere and is designed for emitting fluorescent light, the intensity of the emitted fluorescent light being dependent on the oxygen partial pressure in the shielding atmosphere.

3. The device as claimed in claim 2, the optical oxygen sensor having at least one device for optically exciting the fluorescing medium and at least one optical detector for sensing electromagnetic radiation that is given off by the fluorescing medium as a result of a deactivation process.

4. The device as claimed in claim 3, the device for exciting the fluorescing medium being designed to give off an excitation pulse to the fluorescing medium at previously determinable time intervals.

5. The device as claimed in claim 3, the device having an evaluation unit, which is connected to the optical detector and is designed for determining the intensity or the decay behavior of the fluorescent radiation of the fluorescing medium.

6. The device as claimed in claim 5, the evaluation unit having a microprocessor for calculating the oxygen content of the shielding atmosphere on the basis of the intensity or the decay behavior of the fluorescent light sensed by the optical detector.

7. The device as claimed in claim 6, the evaluation unit being connected to an alarm device and the alarm device being designed to emit an optical and/or acoustic alarm signal as soon as the oxygen content of the shielding atmosphere exceeds a previously determined or determinable limit value.

8. The device as claimed in claim 1, the device having an intake unit, which is designed for the purpose of taking in a sample of the shielding atmosphere, preferably in the direct vicinity of a weld seam, before and/or during a welding process, and feeding it to the optical sensor element.

9. A welding system, which has a welding device and a device for measuring the oxygen content as claimed in claim 1.

10. The welding system as claimed in claim 9, the welding device being designed as an orbital welder, for welding pipes.

11. The welding system as claimed in claim 10, the welding device designed as an orbital welder having a closed housing, which is designed as a shielding chamber for receiving a shielding gas.

12. The welding system as claimed in claim 11, the device for measuring the oxygen content being arranged inside the closed housing of the welding device designed as a shielding chamber and being designed for determining the oxygen content within the housing.

13. The welding system as claimed in claim 9, the welding system also having a second device for measuring the oxygen content, the second device for measuring the oxygen content also having at least one sensor element for sensing the oxygen content of the shielding atmosphere, wherein the sensor element of the second device is designed as an optical oxygen sensor, the second device being designed for measuring the oxygen content within a lumen of two pipes to be welded.

14. A method for measuring the oxygen content in welding processes, the method having the following steps:
Providing a shielding atmosphere in the direct vicinity of a welding point;
providing at least one sensor element for sensing the oxygen content of the shielding atmosphere;
measuring the oxygen content of the shielding atmosphere, before and/or during the welding process characterized in that the oxygen content of the shielding atmosphere is measured optically.

15. The method as claimed in claim 14, the oxygen content of the shielding atmosphere being determined by means of fluorescence quenching at a fluorescing medium.

16. The method as claimed in claim 15, the fluorescing medium being optically excited in a pulsed manner at previously determinable time intervals.

17. The method as claimed in claim 15, the measurement of the oxygen content of the shielding atmosphere comprising a step for sensing the intensity of the decay curve of the fluorescent light emitted by the fluorescing medium.

18. The method as claimed in claim 14, an optical and/or acoustic alarm signal being generated as soon as the oxygen content of the shielding atmosphere exceeds a previously determined or determinable limit value.

19. The method as claimed in claim 14, the determined values for the oxygen content of the shielding atmosphere being stored in a data memory, preferably continuously.
